(19) United States
(12) Patent Application Publication
(10) Pub. No.: US 2017/0276548 A1
(43) Pub. Date: Sep. 28, 2017

(54) Optical Nonlinearity Estimation Using Increase in Harmonic Content With Increase in Intensity

(71) Applicant: Harris Corporation, Melbourne, FL (US)

(72) Inventors: David Stanley SMITH, Fort Wayne, IN (US); Paul MAURER, Fort Wayne, IN (US)

(21) Appl. No.: 15/081,244

(22) Filed: Mar. 25, 2016

(51) Int. Cl. G01J 5/00; G01J 5/12; G01J 5/62; G01J 5/28

(52) U.S. Cl. CPC G01J 5/0003; G01J 5/28; G01J 5/12; G01J 5/62

(57) ABSTRACT

A method of estimating non-linearity in a response of an optical detector comprises emitting optical radiation at different intensities. The method includes, at each intensity: amplitude modulating the emitted optical radiation at a modulating frequency to produce amplitude modulated optical radiation; detecting the amplitude modulated optical radiation with the optical detector to produce a detected waveform; and generating a Fourier transform of the detected waveform that includes a fundamental frequency equal to the modulating frequency and harmonics thereof. The method further includes estimating the non-linearity in the response of the optical detector based on a change in an amplitude of a second harmonic of the fundamental frequency relative to an amplitude of the fundamental frequency across the Fourier transforms corresponding to the different intensities.

### TECHNICAL FIELD

The present disclosure relates to techniques for estimating optical detector nonlinearity.

### BACKGROUND

Optical detectors and associated electronic circuitry used to amplify signals output by the detector are more or less inherently nonlinear with a dependence on operating conditions, and range of fluxes to be detected. An important factor in calibration of an optical system using optical detectors is the extent to which linearity of a transfer/response function of the system, from light energy input to the system to electrical energy output by the system, can be assumed. If the output versus (vs.) input energy is nonlinear, then either error associated with that nonlinearity must be tolerated, or a correction needs to be applied to a calibration equation(s) to account for that nonlinearity. In order to provide a viable correction, nonlinearity of the system (or the relative lack thereof) needs to be measured accurately to enable the system to be calibrated accurately; otherwise, the system will be calibrated incorrectly, which may introduce even more system nonlinearity and calibration uncertainty. Conventional nonlinearity measurements estimate (often incorrectly) a value of optical flux applied to the optical detector, and fit a straight line to the detector output vs. flux, and then assume that any deviation from a straight line can be assigned to nonlinearity of the detector only, rather than to nonlinearity in test equipment used to apply the optical flux. Errors inherent in estimating the value of the input optical flux directly negatively impact accuracy in the measured nonlinearity and may result in a false indication of the presence of nonlinearity.

### BRIEF DESCRIPTION OF THE DRAWINGS

FIG. 1 is a diagram of an example apparatus for estimating/measuring nonlinearity in a response of an optical detector.

FIG. 2 is a view of an example light chopper that may be used as a light modulator in the apparatus.

FIG. 3 is a screen shot of an example nearly sinusoidal 10 Hz chopped black body waveform and an example perfect sinusoidal 10 Hz waveform.

FIG. 4 is a screen shot of an example Fourier transform of the chopped black body waveform from FIG. 3.

FIG. 5 is a screen shot of an example Fourier transform of a detected waveform output by an optical detector in the apparatus, where the optical detector has a linear response.

FIG. 6 is a screen shot that shows an example perfect 10 Hz sine wave applied to a nonlinear system and an example distorted sine wave output from the nonlinear system in response to the input.

FIG. 7 is a screen shot that shows an example Fourier transform of the perfect sine wave of FIG. 6 and an example Fourier transform of the distorted sine wave from FIG. 6.

FIG. 8A is a screen shot that shows example detected waveforms output by a first example optical detector (used in the apparatus) that is nonlinear in response to different intensity chopped black body waveforms produced at different temperatures of a black body radiator of the apparatus.

FIG. 8B is a screen shot that shows example superimposed normalized Fourier transforms of the detected waveforms from FIG. 8A.

FIG. 8C is a screen shot that shows example plots of harmonic amplitudes (from FIG. 8B) vs. estimated flux/intensity representative of nonlinearity in a response of the first example optical detector.

FIG. 9A is a screen shot that shows example superimposed normalized Fourier transforms of detected waveforms output by a second example optical detector that is linear.

FIG. 9B is a screen shot that shows example plots of harmonic amplitudes (from FIG. 9A) vs. relative energy produced by the black body radiator.

FIG. 10 is a flowchart of an example method of estimating nonlinearity in a response of an optical detector performed using the apparatus.

FIG. 11 is a block diagram of an example computer device or system representative of an analyzer of the apparatus.

### DESCRIPTION OF EXAMPLE EMBODIMENTS

### Overview

A method of estimating non-linearity in a response of an optical detector comprises emitting optical radiation at different intensities and, at each intensity: amplitude modulating the emitted optical radiation at a modulating frequency to produce amplitude modulated optical radiation; detecting the amplitude modulated optical radiation with the optical detector to produce a detected waveform; and generating a Fourier transform of the detected waveform that includes a fundamental frequency equal to the modulating frequency and harmonics thereof. The method further comprises estimating the non-linearity in the response of the optical detector based on a change in an amplitude of a second harmonic of the fundamental frequency relative to an amplitude of the fundamental frequency across the Fourier transforms corresponding to the different intensities.

### Example Embodiments

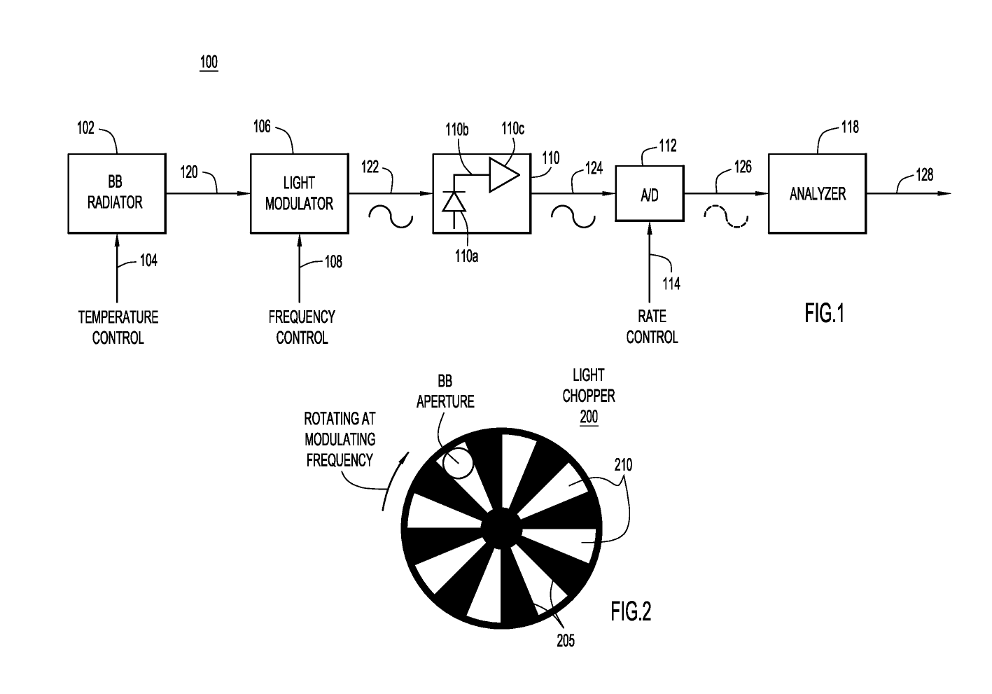

With reference to FIG. 1, there is depicted a diagram of an example apparatus 100 (also referred to as a test system 100) for estimating/measuring/determining nonlinearity in a response of an optical detector. Apparatus 100 includes a black body (BB) radiator 102 having a temperature control input 104, a light modulator 106 having a modulating frequency control input 108, an optical detector 110, an analog-to-digital (A-to-D) converter or digitizer 112 having a digitizing or sampling rate control input 114, and a signal analyzer 118. In the context of apparatus 100, optical detector 110 is considered a unit-under-test. Black body radiator 102, held at a controlled temperature responsive to temperature control input 104, emits optical radiation 120 from an aperture of the black body radiator (not shown in FIG. 1) toward light modulator 110. Black body radiator 102 emits optical radiation 120 at a level of optical flux (also referred to as “intensity”) that is a function of the temperature of the black body radiator in accordance with Planck's law. Light modulator 106 amplitude modulates optical radiation 120 at a modulating frequency responsive to modulating frequency control input 108, to produce amplitude modulated optical radiation 122 at a controlled, single frequency.

Amplitude modulated optical radiation 122 impinges on optical detector 110. Optical detector 110 detects amplitude modulated optical radiation 122 impinging thereon, to produce an electrical detected waveform 124 representative of the intensity of the impinging optical radiation. In a typical configuration, optical detector 110 includes (i) a photodetector 110a that converts optical radiation to an electrical signal 110b, and (ii) an electrical amplifier 110c, coupled to an output of the photodiode, thermal, or other type of detector, to amplify the electrical signal to produce an amplified electrical signal as detected waveform 124.

Digitizer 112 digitizes detected waveform 124 at a sampling rate set by sampling rate control input 114, to produce a digitized detected waveform 126, and provides the digitized waveform to analyzer 118. Analyzer 118 estimates/determines nonlinearity of the optical detector based on the digitized detected waveform, and outputs an estimated/determined nonlinearity 128. Waveforms 124 and 126 may each be referred to as the “detected waveform” output by optical detector 110.

A method of estimating nonlinearity of optical detector 110 using apparatus 100 is now described. Black body radiator 102 is controlled to emit optical radiation 120 at successively increasing known temperatures to produce optical radiation 120 at successively increasing intensities each corresponding to a corresponding one of the temperatures. For example, (i) for a first time period during which black body radiator 102 is held at a known first temperature, the black body radiator emits optical radiation at a first intensity corresponding to the first temperature, (ii) for a second time period following the first time period and during which the black body radiator 102 is held at a known second temperature greater than the first temperature, the black body radiator emits black body radiation at a second intensity greater than the first intensity corresponding to the second temperature, and so on. The range of temperatures may cause black body radiator 102 to emit black body radiation over a range of wavelengths in the light spectrum, including ultraviolet, infrared, and/or visible wavelengths.

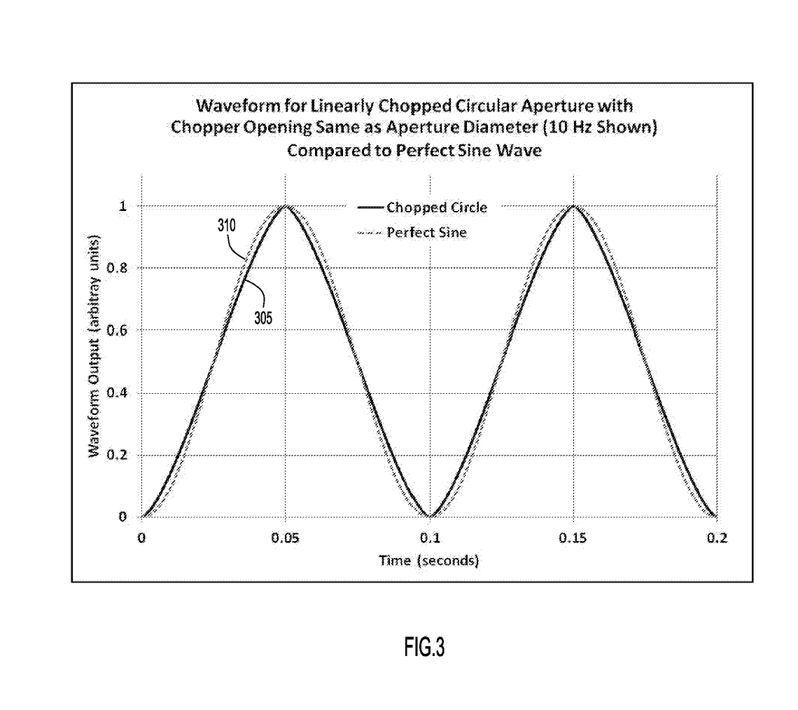

At each temperature and corresponding intensity (i.e., “temperature/intensity”), light modulator 106 amplitude modulates optical radiation 120 at the modulating frequency to produce amplitude modulated optical radiation 122 for the corresponding temperature/intensity. In an embodiment, light modulator 106 may be a light chopper positioned between black body radiator 102 and optical detector 110 and that rotates at the modulating frequency to produce the amplitude modulated optical radiation as chopped radiation. An example light chopper is described below in connection with FIG. 2. Generally, the light chopper produces amplitude modulated optical radiation 122 as a near sinusoidal waveform that is reasonably symmetric above and below an average amplitude of the sinusoidal waveform. That being said, an advantage of the method of estimating nonlinearity described herein is that the accuracy of the estimated nonlinearity is not reduced appreciably if the amplitude modulated optical radiation from the light chopper follows an imperfect or distorted sinusoidal waveform compared to a perfect or near perfect sinusoidal waveform. That is, the accuracy in the estimated nonlinearity remains relatively constant as the amplitude modulated optical radiation moves from the near sinusoidal waveform to the imperfect or distorted sinusoidal waveform. Amplitude modulators other than a light chopper may be used in other examples of apparatus 100, provided they produce amplitude modulation that is nearly sinusoidal and only primarily symmetrically distorted about (above and below) an average value, and that does not suffer from growth in second or other even harmonics while producing the various intensities as modulated.

Optical detector 110 detects amplitude modulated optical radiation 122 impinging on the optical detector at each intensity corresponding to each temperature of black body radiator 102, to produce detected waveform 124 for each intensity. In turn, digitizer 112 digitizes detected waveform 124 for each intensity, to produce digitized detected waveform 126 for each intensity, and provides each digitized detected waveform to analyzer 118. Thus, analyzer 118 receives successive digitized detected waveforms corresponding to successive ones of the temperatures/intensities of/from black body radiator 102. Digitizer 112 samples detected waveform 124 at an adequately high sampling frequency/rate to allow accurate analysis of a fundamental frequency of detected waveform 124 and many harmonics of the fundamental frequency. For purposes of analysis, the fundamental frequency of detected waveform 124 is the amplitude modulating frequency. In an example in which the amplitude modulating frequency (and thus the fundamental frequency) is in a range of 10-100 Hz, it is preferable to sample detected waveform 124 at a rate in a range that is at least an order or magnitude higher than the modulating frequency (e.g., 10,000 Hz to 100,000 Hz) in order to provide a large number (high density) of samples in digitized waveform 126.

Analyzer 118 processes successive digitized waveforms 126 corresponding to the successive temperatures/intensities, and estimates optical detector nonlinearity or relative lack thereof based on results of the processing. First, analyzer 118 generates a Fourier transform of digitized waveform 126 for each intensity, to produce Fourier transforms each corresponding to a respective one of the successive intensities/temperatures. In an example, analyzer 126 computes the Fourier transforms as Fast Fourier transforms (FFTs). Each Fourier transform includes a fundamental frequency (the modulating frequency) and harmonics thereof. Analyzer 118 estimates nonlinearity of optical detector 110 based on a change in an amplitude primarily of the second harmonic of the fundamental frequency relative to an amplitude of the fundamental frequency across the Fourier transforms corresponding to the different intensities. In one example, normalized amplitudes of the second harmonics (i.e., normalized with respect to the amplitude of the fundamental frequency in the same Fourier transform) are plotted against their corresponding temperatures. In another example, the normalized amplitudes are plotted against rough estimates of their corresponding intensities. The nonlinearity of optical detector 110 is proportional to an increase in the normalized amplitudes with an increase in intensity; thus, if the normalized amplitudes remain relatively flat as intensity increases, then the optical detector is relatively linear. The above described techniques are described in further detail below.

With reference to FIG. 2, there is a face-on view of an example light chopper 200 that may be used in light modulator 106. Light chopper 200 includes a face plate formed similarly to a “wagon wheel” with alternating equally-sized opaque sections 205 and transmitting openings 210. In apparatus 100, light chopper 200 is positioned between black body radiator 102 and optical detector 110, but nearest to the black body. In operation, the face plate rotates at a controlled rate in order to produce the modulating frequency (the fundamental frequency). The alternating arrangement of opaque sections 205 and openings 210 causes the rotating face plate to intermittently block optical radiation from the emitting aperture of the black body (or other appropriate source), and allow optical radiation to pass to, optical detector 110. As seen at optical detector 110, modulated optical radiation 122 emerging from the rotating faceplate has nearly a sinusoidal waveform because of the geometric relationship between the emitting aperture of the black body and the chopper openings.

A theoretical basis for the method of estimating nonlinearity presented herein is described below under the Sections Theory 1, Theory 2, and Theory 3. Then, two examples of estimating nonlinearity are described. The descriptions assume, by way of example only, an arrangement of apparatus 100 that includes black body radiator 102 followed by a light chopper as optical modulator 106. In this arrangement, the combination of black body radiator 102 followed by the light chopper is referred to as a “chopped black body,” and modulated optical radiation 122 produced by the chopped black body is referred to as a “chopped black body waveform.” Also, the terms “intensity” and “flux” are used synonymously and interchangeably.

Theory 1

When a linear optical system is stimulated with a modulated input waveform, an output signal of the linear optical system is expected to be a faithful representation of the modulated waveform albeit amplified by some factor (system gain), shifted in phase, or possibly offset by a fixed direct current (d.c.) level. For a linear optical system, the output will be a perfect sinusoid if the input is a perfect sinusoid.

In a case of an imperfectly modulated input waveform (as will generally be true in all practical/realizable applications), a linear system/detector with a bandwidth much higher than a fundamental frequency (i.e., amplitude modulating frequency) will faithfully reproduce the input waveform with the same distortions inherently present in the input waveform; however, if the system/detector is nonlinear, distortion will be made worse by the nonlinearity. If the system/detector has a finite-bandwidth, amplitudes of a fundamental frequency and harmonics thereof will be reduced in amplitude.

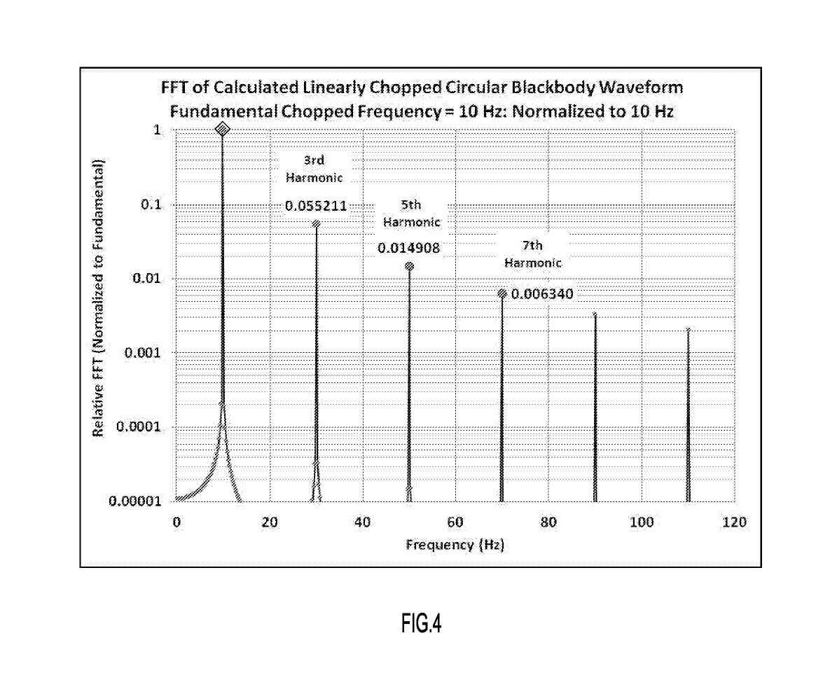

As discussed above, a chopped black body may be used to provide input flux to optical detector 110 for measurements of responsivity and nonlinearity of the optical detector. If (i) the temperature of black body radiator 102 of the chopped black body is known accurately, and (ii) the transmissive characteristics of space and any objects between optical detector 110 and the black body radiator are known accurately, then the flux (i.e., intensity) emitted by the black body radiator onto the detector is calculable using Planck's law. The light chopper of the chopped black body alternately obscures and opens a view of the black body aperture to a view of optical detector 110, thus providing a chopped black body waveform (e.g., amplitude modulated optical radiation 122) to the optical detector. If a defining boundary between each opening and adjacent opaque area of the chopper is essentially a straight line, and the black body aperture is circular and of the same size as the opening, the chopped black body waveform is nearly a sinusoid as shown in FIG. 3. With reference to FIG. 3, there are shown example time vs. amplitude plots of (i) a nearly/approximately sinusoidal/slightly distorted 10 Hz chopped black body waveform 305 (shown in solid line), and (ii) a perfect sinusoidal 10 Hz waveform 310 for comparison (shown in dotted line).

After the chopped black body waveform has been detected and passed through a linear system, such a linear optical detector with a finite bandwidth, the detected waveform (e.g., detected waveform 124) produced by the linear system is closer to sinusoidal than the original input waveform (e.g., the input chopped black body waveform) because of a reduction in higher frequency (harmonic) content. In contrast, systems with a higher frequency response reproduce the original shape of the input waveform more faithfully. Advantageously, the method of estimating nonlinearity presented herein does not depend on maintaining the higher frequency harmonic content (i.e., frequency components) of the chopped black body waveform input to optical detector 110, nor does the method require a perfect sinusoidal shape for the chopped black body waveform. This is because the method estimates nonlinearity based on a change of normalized harmonic content in detected waveform 124 corresponding to a change in input flux of the chopped black body waveform. The method normalizes the harmonic content to the fundamental frequency of detected waveform 124, as represented in a Fourier transform of the detected waveform, as described below.

Theory 2

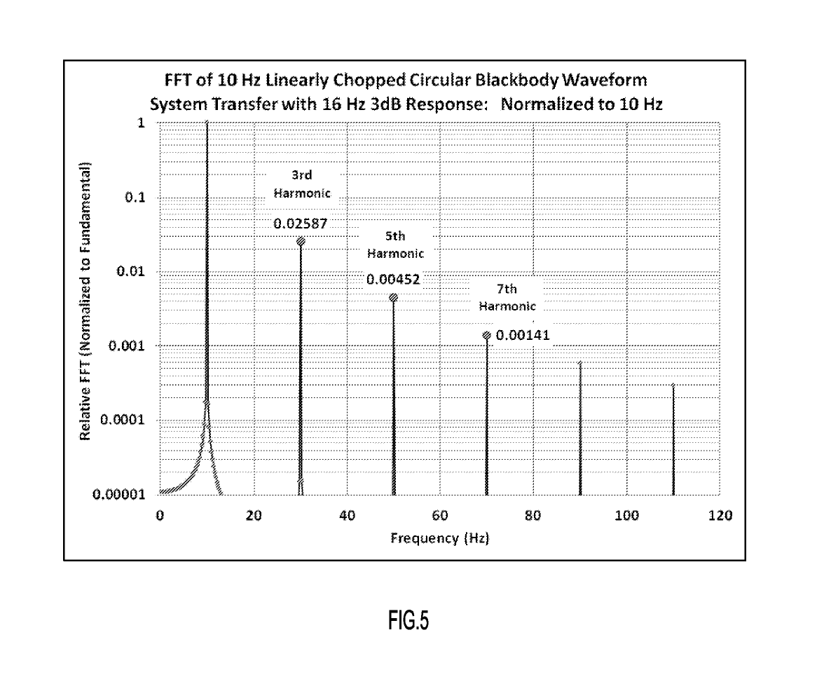

The method of estimating nonlinearity is based on Fourier transforms (e.g., FFTs) of detected waveform 124/126 corresponding to the different fluxes (i.e., intensities) of the chopped black body waveform applied to optical detector 110. With reference to FIG. 4, there is a comparison between example frequency vs. amplitude plots of (i) a Fourier transform of the chopped black body waveform 305 from FIG. 3, in which the Fourier transform includes a fundamental frequency of 10 Hz (see the frequency component amplitudes marked by a circle), and (ii) a Fourier transform of the perfect 10 Hz sine wave 310, also from FIG. 3 (see the single fundamental frequency component amplitude marked with a diamond). The Fourier transform for the perfect sine wave shows frequency content only at one frequency, e.g., at 10 Hz, while the Fourier transform of the chopped black body waveform shows content at odd integer multiples of the fundamental frequency, e.g., at 30 Hz, 50 Hz, 70 Hz, and so on, consistent with normal expectations for a non-sinusoidal waveform symmetrically distorted above and below its average amplitude value.

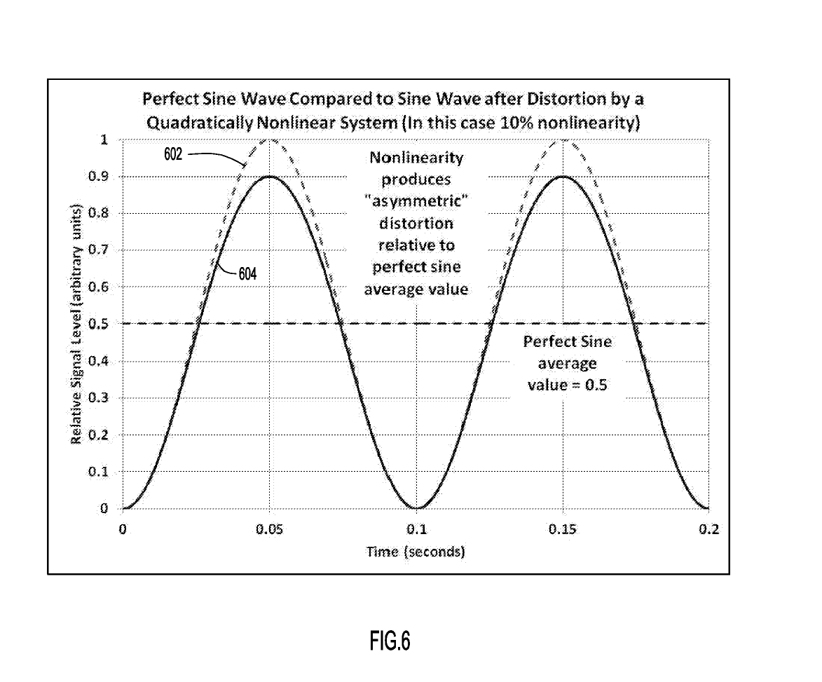

As stated above, if optical detector 110 is linear, then detected waveform 124/126 has similar relative frequency content to the chopped black body waveform, albeit possibly modified by a frequency dependent gain and phase shift, as shown in FIG. 5. With reference to FIG. 5, there is shown an example plot of a Fourier transform of detected waveform 124/126, where the optical detector 110 is linear and has a frequency response with a 16 Hz roll-off. A comparison of the FIG. 4 Fourier transform of the chopped black body waveform (prior to optical detector 110) against the FIG. 5 Fourier transform of detected waveform 124/126 (after the optical detector) reveals that that the linear optical detector reduces the amplitudes of harmonic content, but has not modified the frequencies at which the harmonic content appears.

Theory 3

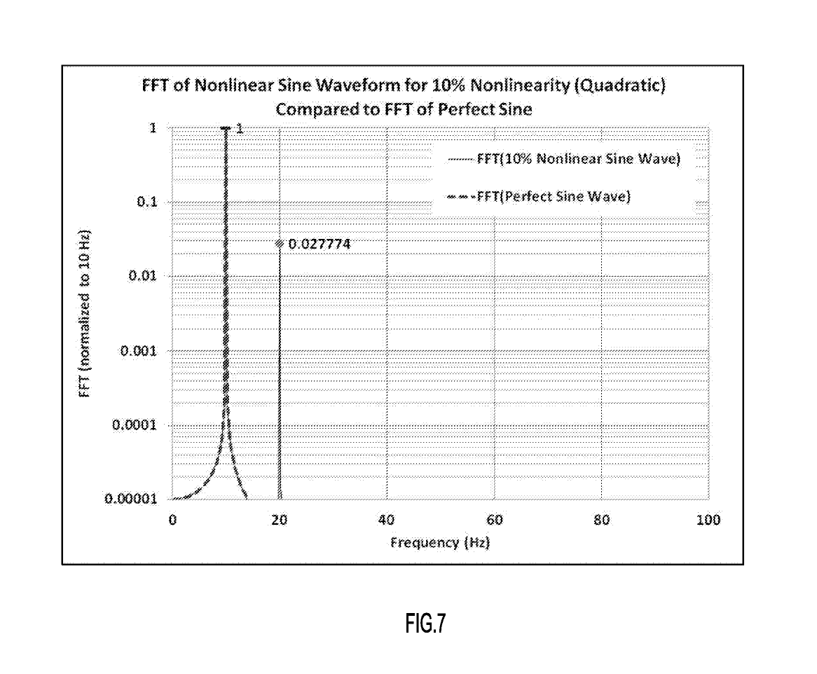

In apparatus 100, optical components positioned between black body radiator 102 and optical detector 110 may be nonlinear, and the optical detector itself may be nonlinear. As mentioned already, a nonlinear system distorts the shape of a waveform from an input of the system to an output of the system, as shown in FIG. 6. With reference to FIG. 6, there is a comparison between an example plot of a perfect 10 Hz sine wave 602 applied to a nonlinear system and an example plot of a distorted sine wave 604 output from the nonlinear system in response to the input. The example of FIG. 6 is an illustration of a nonlinearity of 10% (2^{nd} order or “quadratic”). The nonlinearity creates asymmetric amplitude distortion of perfect sine wave 602 above and below the average amplitude value, as exhibited in distorted sine wave 604.

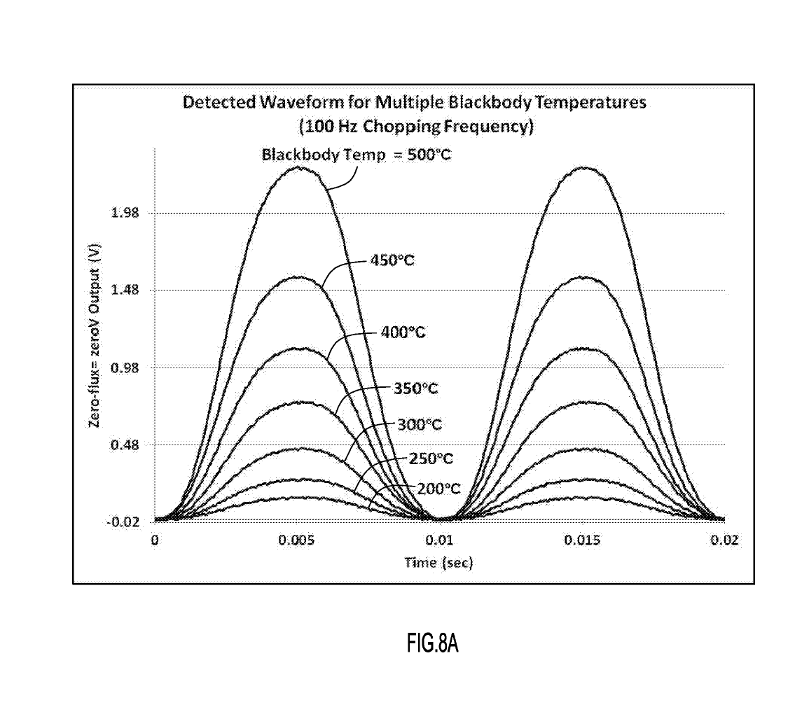

With reference to FIG. 7, there is shown a comparison between a Fourier transform of perfect sine wave 602 (frequency components shown in dashed line) and a Fourier transform of distorted sine wave 604 (frequency components shown in solid line). As seen in FIG. 7, distorted sine wave 604 includes even (2^{nd}) harmonic content at 20 Hz, which has appeared as a result of the distortion of the perfect sine wave 602 by system nonlinearity. The method of detecting nonlinearity presented herein is based on the behavior of the even harmonics, specifically and primarily the 2^{nd} harmonic of the fundamental frequency, produced by passing a signal through a nonlinear system, which results in asymmetric amplitude distortion above and below the average amplitude.

Appearance of even harmonics is necessary for asymmetrically nonlinear systems; however, in apparatus 100, the mere appearance of even harmonics in a Fourier transform of detected waveform 124/126 does not necessarily mean that nonlinearity is present only in optical detector 110, because nonlinearity may also exist in the chopped black body that produces the chopped black body waveform applied to the optical detector. For example, original asymmetric distortion may be “built-into” the chopped black body waveform (possibly geometric or other fixed cause), in which case the even harmonic content will remain constant as a function of flux (i.e., will not change with a change in flux) because the chopped black body arrangement is fixed in a given apparatus and thus does not change with a change in the flux. That is, the chopped black body waveform is determined by the relationship between the light chopper and the black body aperture, and is independent of the temperature and flux. While the contribution to the even harmonic content from a nonlinearly chopped black body will not change with a change in flux, the contribution to the even harmonic content will change with a change in flux if optical detector 110 is also asymmetrically nonlinear. In other words, in the aforementioned situation, a change in the even harmonic content corresponding to a change in flux is indicative of nonlinearity of optical detector 110, only. Thus, estimating nonlinearity based on a change in the even harmonic content effectively subtracts-out the effect of nonlinearity in the test arrangement used in the estimating, and thus focuses instead on exposing nonlinearity of the unit under test, i.e., of optical detector 110.

Described below are two examples uses of the method of estimating linearity/nonlinearity of optical detector 110, including a first example in which optical detector 110 has a nonlinear response, and a second example in which the optical detector has a linear response. In each example, generally: The chopped black body emits successively increasing optical radiation intensities at successively increasing temperatures of the black body radiator; optical detector 110 detects the chopped black body radiation resulting from the successive temperatures/intensities, to produce detected waveform 124/126 at each of the successive temperatures/intensities; for each successive temperature/intensity, analyzer 118 generates a Fourier transform of the corresponding detected waveform, to produce successive Fourier transforms for the successive black body temperatures/intensities; and the analyzer estimates nonlinearity/linearity based on the Fourier transforms. Analyzer 118 plots and displays results of the estimating.

### Example 1—Nonlinear Optical Detector

In the first example, optical detector 110 includes an infrared (IR) photoconductive detector that has an expected nonlinear response to flux levels in the infrared applied to the detector by the chopped black body at different temperatures of black body radiator 102. The detector includes a 1.3 millimeter² (mm²) light detector area, and operates with a bias current of 1 mA at a quiescent temperature of 99K. The chopped black body waveform applied to the detector has a chopped frequency (i.e., an amplitude modulating/fundamental frequency) of 100 Hz.

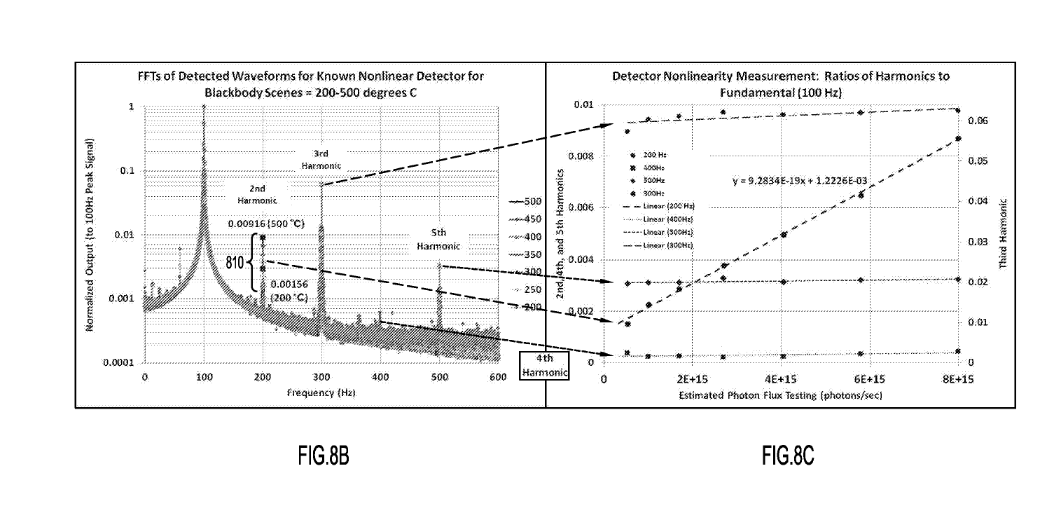

Illustrations of results produced and used by the method of estimating nonlinearity in example 1 are shown in FIGS. 8A, 8B, and 8C. FIG. 8A shows example time vs. voltage plots for 7 detected waveforms output by the detector, each detected waveform resulting from a respective one of 7 successively increasing intensities of the chopped black body waveform corresponding to 7 successively increasing temperatures of black body radiator 102, including 200K, 250K, 300K, 350K, 400K, 450K, and 500K. FIG. 8B shows superimposed example frequency vs. amplitude plots of 7 normalized Fourier transforms of the detected waveforms from FIG. 8A. Thus, each Fourier transform in FIG. 8B corresponds to a respective one of the 7 detected waveforms 124/126 in FIG. 8A, a respective one of the 7 successively increasing intensities, and a respective one the 7 successively increasing temperatures of black body radiator 102. That is, FIG. 8B shows: a first Fourier transform of the detected waveform for a first intensity emitted by black body radiator 102 held at 200K; superimposed on the first Fourier transform, a second Fourier transform of detected waveform 124/126 for a second intensity emitted by the black body radiator held at 250K; superimposed on the first second Fourier transforms, a third Fourier transform of detected waveform 124/126 for a third intensity emitted by the black body radiator held at 300K; and so on.

Each Fourier transform depicted in FIG. 8B is normalized, meaning that, in a given Fourier transform, peak amplitudes of the harmonics at 200 Hz, 300 Hz, 400 Hz, 500 Hz, and 700 Hz are normalized to a peak amplitude of the fundamental frequency at 100 Hz of the given Fourier transform. Any technique may be used to normalize the amplitudes of the harmonics to the fundamental frequency in a given Fourier transform. In one example, a given harmonic peak amplitude is normalized by dividing that harmonic peak amplitude by the fundamental frequency peak amplitude in the same Fourier transform.

As shown in FIG. 8B, at 810, as the temperatures and corresponding intensities successively increase (e.g., as the temperature increases from 200K to 500K), the normalized peak amplitudes of the second harmonic also successively increase across the Fourier transforms (shown as different amplitudes at frequency 200 Hz) corresponding to the increase in intensity, as is also shown in FIG. 8C. FIG. 8C shows plots of harmonic amplitudes (from FIG. 8B) vs. estimated flux (i.e., intensity). That is, normalized harmonic peak amplitudes at 200 Hz, 300 Hz, 400 Hz, and 500 Hz depicted in FIG. 8B are plotted as a function of flux (intensity) in FIG. 8C. As shown in FIG. 8C, the increase (more generally, change) in the second harmonic amplitude in correspondence with the increase in intensity follows a relatively straight line, such that a slope of the line represents an estimate or measure of nonlinearity.

The plots of FIGS. 8B and 8C also reveal that the only harmonic peak amplitude that depends significantly on flux is the second harmonic peak amplitude which ranges from ˜0.15% to 0.9% of the fundamental frequency peak amplitude. The 3^{rd}, 4^{th}, and 5^{th} harmonics (and above) have peak amplitudes that are essentially independent of flux. A reason for the increase in the 2^{nd} harmonic is that the 2^{nd} harmonic is a measure of asymmetric distortion caused by the detector nonlinearity as flux increases, as discussed above in the Theory sections. The estimated flux in FIG. 8C may be calculated based on the known temperatures of black body radiator 102 and Planck's law. Since the method herein depends on changes in detected intensities and not absolute values of the intensities, the estimated flux need only be approximately or roughly accurate without significantly negatively impacting the estimated nonlinearity of the detector.

### Example 2—Linear Optical Detector

In the second example, optical detector 110 includes a 1.5 mm² thermopile detector that has an expected linear response to flux levels in the infrared applied to the detector by the chopped black body at different temperatures of black body radiator 102. The black body chopped waveform applied to the detector has a chopped frequency of 10 Hz.

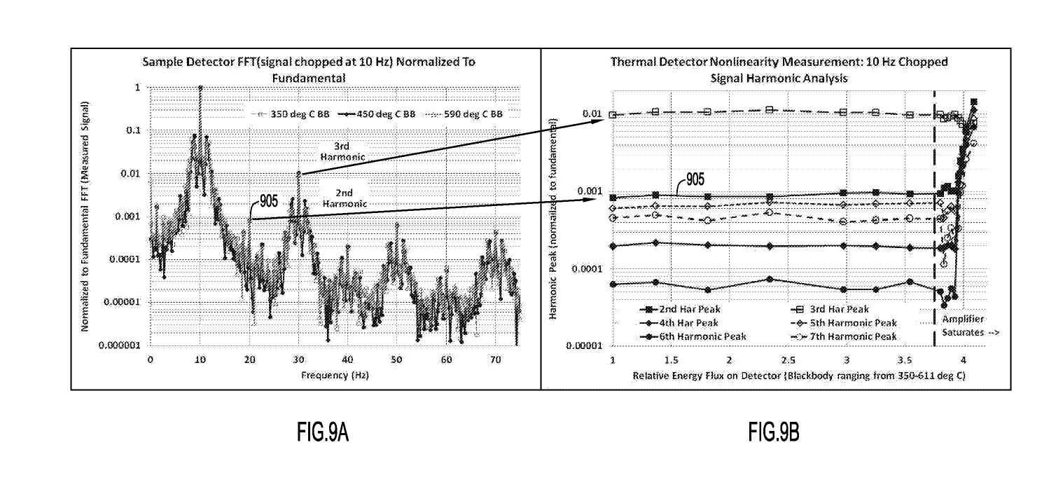

Illustrations of results produced and used by the method of estimating nonlinearity (or relative lack thereof) in example 2 are shown in FIGS. 9A and 9B. FIG. 9A shows superimposed plots of normalized Fourier transforms of detected waveform 124/126 output by the detector corresponding to multiple temperatures/intensities of black body radiator 102, where the temperatures range from 600K to 900K. As shown in FIG. 9A at 905, as temperatures and corresponding intensities increase (e.g., over a temperature increase from 600K to 900K), the normalized peak amplitudes of the second harmonic do not change, i.e., remain relatively constant, across the Fourier transforms, as is also shown in FIG. 9B. FIG. 9B shows plots of harmonic amplitudes (from FIG. 9A) vs. temperature of the black body radiator (which corresponds to intensity emitted thereby). That is, normalized harmonic peak amplitudes at 20 Hz, 30 Hz, 40 Hz, 50 Hz, 60 Hz, and 70 Hz depicted in FIG. 9A are plotted as a function of relative black body energy flux (calculated for each black body temperature using Planck's Law) in FIG. 9B. As shown in FIG. 9B, the second harmonic amplitude is relatively flat across all intensities), indicating approximately zero nonlinearity, i.e., that the detector is linear. In this case, standard statistical analysis techniques may be applied to estimate the limit to how well the absence of nonlinearity is confirmed.

High-Level Method Flowchart

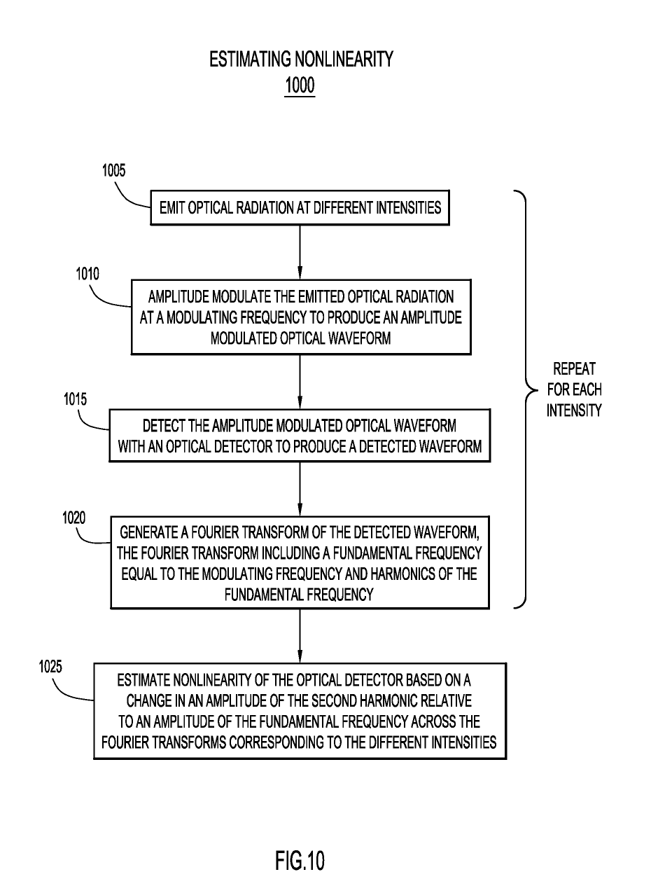

With reference to FIG. 10, there is a flowchart of an example method 1000 of estimating/measuring nonlinearity in a response of optical detector 110 using apparatus 100.

At 1005, black body radiator 102 emits optical radiation at different intensities. In other embodiments, an optical emitter other than a black body radiator may be used.

At each intensity:
a. At 1010, light modulator 106 amplitude modulates the emitted optical radiation at a modulating frequency to produce amplitude modulated optical radiation 122;
b. At 1015, optical detector 110 detects amplitude modulated optical radiation 122 to produce a detected waveform 124/126; and
c. At 1020, analyzer 118 generates a Fourier transform of detected waveform 124/126 that includes a fundamental frequency equal to the modulating frequency, and harmonics of the fundamental frequency. Analyzer 118 normalizes an amplitude of the second harmonic in the Fourier transform to an amplitude of the fundamental frequency in that Fourier transform.

At 1025, analyzer 118 estimates the non-linearity in the response of optical detector 110 based on a change in the amplitudes of the second (and to lesser extent the higher even-numbered harmonics) harmonics of the fundamental frequency relative to the amplitudes of the fundamental frequency across the Fourier transforms corresponding to the different intensities. For example, analyzer 118 may estimate the non-linearity based on a change in the normalized amplitudes of the second harmonics across the different Fourier transforms for purposes of performing a quadratic nonlinearity correction for the optical detector during calibration

In one embodiment, at 1025, analyzer 118 estimates each intensity based on the temperature of black body radiator 102 that caused the black body radiator to emit the radiation corresponding to that intensity, and Planck's law; and plots the normalized amplitudes of the second harmonics against the corresponding estimated intensities, to produce a plot of the normalized second harmonic amplitudes having a slope representative of the non-linearity, as shown in FIGS. 8C and 9B.

In another embodiment, at 1025, analyzer 118 plots the normalized amplitudes of the second harmonics against the corresponding temperatures, to produce a plot of the normalized second harmonic amplitudes having a slope representative of the non-linearity.

Analyzer 118 may display as screen shots the detected waveforms, plots of the Fourier transforms, and a plot of the normalized amplitude vs. temperature or intensity, and may display a determined slope value from the plots indicative of nonlinearity.

Analyzer

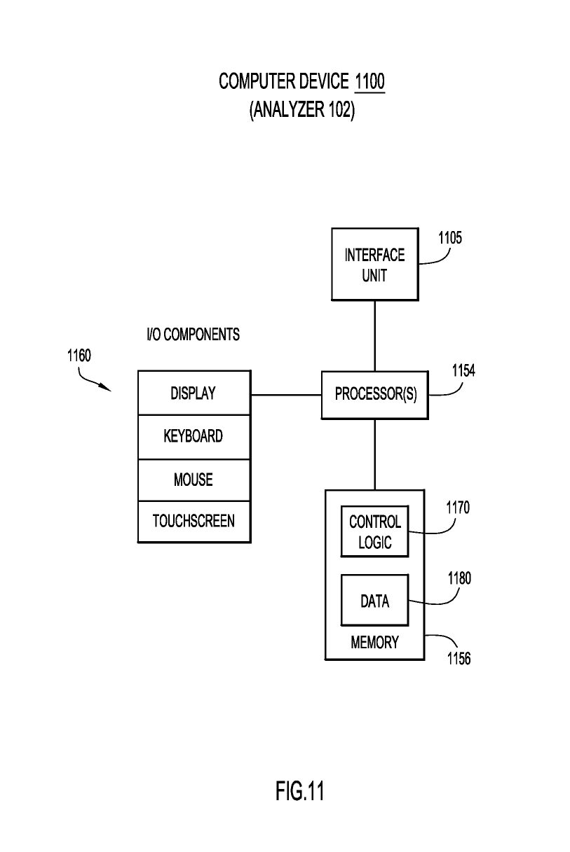

With reference to FIG. 11, there is a block diagram of a computer device or system 1100 representative of analyzer 118. Computer device 1100 includes an interface unit 1105 to communicate with external devices, such as black body radiator 102, light modulator 106, digitizer 112, and optical detector 110, a processor 1154 (or multiple processors), and memory 1156. The memory 1156 stores instructions for implementing server methods or client device methods described herein. Computer device 1100 also includes input/output (I/O) components 1160 connected with processor 1154 including a display for displaying information, and input components, such as a keyboard, mouse, touchscreen, and the like, through which a user may enter information into the computer device.

The memory 1156 may comprise read only memory (ROM), random access memory (RAM), magnetic disk storage media devices, optical storage media devices, flash memory devices, electrical, optical, or other physical/tangible (non-transitory) memory storage devices. The processor 1154 is, for example, a microprocessor or a microcontroller that executes instructions stored in memory. Thus, in general, the memory 1156 may comprise one or more tangible computer readable storage media (e.g., a memory device) encoded with software comprising computer executable instructions and when the software is executed (by the processor 1154) it is operable to perform the operations described herein. Memory 1156 stores control logic 1170 to perform the methods described herein, including estimating nonlinearity of an optical device based on detected waveforms and Fourier transforms, and plotting results of the estimating, as described above. The memory may also store data 1180 used and generated by control logic 1170 as described herein, such as Plank's law equations, temperatures, estimated intensities, digitized detected waveforms, Fourier transforms, and various other information for plotting and displaying results.

### SUMMARY

If an output of an optical detector is nonlinearly related to increasing flux applied to an input of the optical detector, 2^{nd} harmonic content relative to a fundamental component in an alternating current (a.c.) output by the optical detector (i.e., a detected output), responsive to a chopped waveform of light incident on the optical detector, will increase as the flux/intensity of the chopped waveform of light increases. Methods described herein measure an increase in the 2^{nd} harmonic content with an increase in flux, and thus estimate the extent to which the optical detector response is nonlinear. Typically response nonlinearity is relatively small over the range of fluxes characteristic for many applications, so with conventional nonlinearity measurements techniques, estimating an accurate estimate of nonlinearity suffers from error in determination of the flux applied to the detector. In the methods described herein, by measuring the increase (or lack thereof) of the 2^{nd} harmonic relative to the fundamental, the nonlinearity may be characterized advantageously with less than a perfect knowledge of the flux applied to the detector. The methods describe herein provide for an accurate estimation of nonlinearity of an optically responsive element (e.g., an optical detector) while greatly reducing a need for accurately estimating light fluxes applied to the optical detector. The methods also obviate the need to for applying a “perfect” sine-modulated optical source of flux to the optical detector. In the methods, nonlinearity as a function of optical detector operating frequency may be measured.

For the methods described herein, applied flux is only reasonably well-known; however the impact of input flux error on the estimation of the nonlinearity is almost completely mitigated, compared to conventional techniques. Flux error is less important in the methods because the nonlinearity is measured using growth in distortion of the optical detector (response) output relative to the original energy waveform applied to the detector, to produce the output signal as the input signal is increased.

In summary, in one form, a method is provided as described above in the Overview section.

In summary, in another form, an apparatus is provided comprising: an optical emitter to emit optical radiation at different intensities; an amplitude modulator to amplitude modulate the optical radiation at each intensity at a modulating frequency to produce amplitude modulated optical radiation for each intensity; an optical detector to detect the amplitude modulated optical radiation at each intensity to produce a detected waveform for each intensity; and an analyzer to: generate a Fourier transform of the detected waveform for each intensity that includes a fundamental frequency equal to the modulating frequency and harmonics thereof, to produce Fourier transforms each corresponding to a respective one of the intensities; and estimate the non-linearity in the response of the optical detector based on a change in an amplitude of a second harmonic of the fundamental frequency relative to an amplitude of the fundamental frequency across the Fourier transforms corresponding to the different intensities.

In summary, in yet another form, a processor readable medium is provided. The processor readable medium stores instructions that, when executed by a processor, cause the processor to perform the methods described above.

The above description is intended by way of example only. Various modifications and structural changes may be made therein without departing from the scope of the concepts described herein and within the scope and range of equivalents of the claims.

What is claimed is:

1. A method of estimating non-linearity in a response of an optical detector, comprising:
emitting optical radiation at different intensities;
at each intensity:
amplitude modulating the emitted optical radiation at a modulating frequency to produce amplitude modulated optical radiation;
detecting the amplitude modulated optical radiation with the optical detector to produce a detected waveform; and
generating a Fourier transform of the detected waveform that includes a fundamental frequency equal to the modulating frequency and harmonics thereof; and
estimating the non-linearity in the response of the optical detector based on a change in an amplitude of a second harmonic of the fundamental frequency relative to an amplitude of the fundamental frequency across the Fourier transforms corresponding to the different intensities.

2. The method of claim 1, wherein the emitting optical radiation includes emitting the optical radiation as black body radiation from a block body radiator at different temperatures thereof, to produce the different intensities each corresponding to one of the temperatures.

3. The method of claim 2, wherein the estimating the non-linearity includes:
for each Fourier transform, normalizing the amplitude of the second harmonic to the amplitude of the fundamental frequency; and
estimating the non-linearity based on a change in the normalized amplitudes of the second harmonics across the different Fourier transforms.

4. The method of claim 3, wherein the estimating the non-linearity further includes:
estimating each intensity based on the temperature of the black body radiator corresponding to that intensity; and
plotting the normalized amplitudes of the second harmonics against the corresponding estimated intensities, to produce a plot of the normalized second harmonic amplitudes having a slope representative of the non-linearity.

5. The method of claim 4, wherein the estimating each intensity includes estimating each intensity based on the corresponding temperature and Planck's Law.

6. The method of claim 3, wherein the estimating the non-linearity further includes:
plotting the normalized amplitudes of the second harmonics against the corresponding temperatures, to produce a plot of the normalized second harmonic amplitudes having a slope representative of the non-linearity.

7. The method of claim 1, wherein the amplitude modulated optical radiation varies in amplitude according to an approximate sine wave.

8. The method of claim 1, wherein the amplitude modulating includes chopping the optical radiation with a light chopper rotating at a chopper frequency equal to the modulating frequency, to produce as the amplitude modulated optical radiation chopped optical radiation that varies in amplitude according to an approximate sine wave.

9. The method of claim 1, wherein:
the optical detector includes:
a photodetector to convert the amplitude modulated optical radiation to an electrical waveform; and
an amplifier, coupled to an output of the photodetector, to amplify the electrical waveform to produce the detected waveform; and
the estimating the non-linearity includes estimating the non-linearity of the photodetector and the amplifier in combination.

10. The method of claim 1, wherein:
the detecting includes digitizing an output provided by the optical detector to produce a digitized detected waveform; and
the generating the Fourier transform includes performing a Fast Fourier transform of the digitized detected waveform.

11. The method of claim 9, wherein:
the modulating frequency is in a range of 10 Hz to 100 Hz; and
the digitizing includes digitizing the output provided by the optical detector at a sample rate that is at least an order of magnitude higher than the modulating frequency.

12. A apparatus, comprising:
an optical emitter to emit optical radiation at different intensities;
an amplitude modulator to amplitude modulate the optical radiation at each intensity at a modulating frequency to produce amplitude modulated optical radiation for each intensity;
an optical detector to detect the amplitude modulated optical radiation at each intensity to produce a detected waveform for each intensity; and
an analyzer to:
generate a Fourier transform of the detected waveform for each intensity that includes a fundamental frequency equal to the modulating frequency and harmonics thereof, to produce Fourier transforms each corresponding to a respective one of the intensities; and
estimate the non-linearity in the response of the optical detector based on a change in an amplitude of a second harmonic of the fundamental frequency relative to an amplitude of the fundamental frequency across the Fourier transforms corresponding to the different intensities.

13. The apparatus of claim 1, wherein the optical emitter includes a black body radiator to radiate the optical radiation as black body radiation at each temperature, to produce the different intensities each corresponding to one of the temperatures.

14. The apparatus of claim 2, wherein the analyzer is configured to estimating the non-linearity by:
for each Fourier transform, normalizing the amplitude of the second harmonic to the amplitude of the fundamental frequency; and
estimating the non-linearity based on a change in the normalized amplitudes of the second harmonics across the different Fourier transforms.

15. The apparatus of claim 3, wherein the analyzer is further configured to estimate the non-linearity by:
estimating each intensity based on the temperature of the black body radiator corresponding to that intensity; and
plotting the normalized amplitudes of the second harmonics against the corresponding estimated intensities, to produce a plot of the normalized second harmonic amplitudes having a slope representative of the non-linearity.

16. The apparatus of claim 3, wherein the analyzer is further configured to estimate the non-linearity by:
plotting the normalized amplitudes of the second harmonics against the corresponding temperatures, to produce a plot of the normalized second harmonic amplitudes having a slope representative of the non-linearity.

17. The apparatus of claim 1, wherein the amplitude modulated optical radiation varies in amplitude according to an approximate sine wave.

18. The apparatus of claim 1, wherein the amplitude modulator includes a light chopper configured to rotate at a chopper frequency equal to the modulating frequency, to produce as the amplitude modulated optical radiation chopped optical radiation that varies in amplitude according to an approximate sine wave.

19. A method of estimating non-linearity in a response of an optical detector, comprising:
emitting black body radiation from a black body radiator at different temperatures of the black body, to produce different intensities each corresponding to one of the temperatures;
at each intensity:
amplitude modulating the emitted optical radiation at a modulating frequency to produce amplitude modulated optical radiation;
detecting the amplitude modulated optical radiation with the optical detector to produce a detected waveform;
generating a Fourier transform of the detected waveform that includes a fundamental frequency equal to the modulating frequency and harmonics thereof; and
normalizing an amplitude of the second harmonic of the fundamental frequency relative to an amplitude of the fundamental frequency in the Fourier transform; and
estimating the non-linearity in the response of the optical detector based on a change in the normalized amplitudes of the second harmonics across the Fourier transforms corresponding to the different intensities.

20. The method of claim 20, wherein the estimating the non-linearity further includes:
estimating each intensity based on the temperature of the black body radiator corresponding to that intensity; and
plotting the normalized amplitudes of the second harmonics against the corresponding estimated intensities, to produce a plot of the normalized second harmonic amplitudes having a slope representative of the non-linearity.

21. The method of claim 19, wherein the estimating the non-linearity further includes:
plotting the normalized amplitudes of the second harmonics against the corresponding temperatures, to produce a plot of the normalized second harmonic amplitudes having a slope representative of the non-linearity.
